(19) United States
(12) Patent Application Publication
(10) Pub. No.: US 2022/0142393 A1
(43) Pub. Date: May 12, 2022

(54) BEVERAGE SYSTEM FOR PRODUCING A BEVERAGE BY MEANS OF A CAPSULE

(71) Applicant: BSH Hausgeraete GmbH, Muenchen (DE)

(72) Inventors: Evgeni Rehfuss, Muenchen (DE); Tim Glaesser, Mainz (DE)

(21) Appl. No.: 17/438,180

(22) PCT Filed: Mar. 19, 2020
(86) PCT No.: PCT/EP2020/057677

§ 371 Date: Sep. 10, 2021

(30) Foreign Application Priority Data
Mar. 26, 2019 (DE) 10 2019 204 156.6

(51) Int. Cl. A47J 31/40; A47J 31/41; A47J 31/46; A47J 31/60; A47J 31/52; C12G 3/04; B65D 85/804; B67D 1/00; B67D 1/08; B67D 1/10

(52) U.S. Cl. CPC A47J 31/407; A47J 31/41; A47J 31/461; A47J 31/468; A47J 31/60; B67D 1/10; C12G 3/04; B65D 85/8043; B67D 1/0078; B67D 1/0057; B67D 1/0885; A47J 31/5255

(57) ABSTRACT

A beverage system for producing a beverage based on the contents of a capsule. A capsule support for accommodating a capsule and a dispensing unit for providing the beverage produced based on the contents of the capsule. The beverage system has a carbonizing source configured to provide a carbonizing gas in the beverage system, at least one liquid container for receiving a liquid, and at least one carbonizer configured to carbonize liquid from the liquid container using carbonizing gas from the carbonizing source. A liquid line is configured to conduct non-carbonized liquid directly from the liquid container to the capsule, and a liquid line is configured to conduct carbonized liquid from the carbonizer to the capsule.

The invention relates to a beverage system for producing a beverage on the basis of the contents of a capsule.

In a capsule-based beverage system the contents of a capsule introduced into the beverage system may be mixed with at least one further liquid (for example water) in order to provide a portion of a beverage. In this case, for the reliable production of mixed beverages it is typically required that the contents of a capsule are transferred as fully as possible from the capsule into the mixed beverage. Moreover, during the production of a mixed beverage, a contamination of the beverage system by the contents of a capsule should be avoided, in particular in order to be able to use the beverage system in a cost-efficient manner for the production of various mixed beverages.

The present document relates to the technical object of providing a beverage system by which a reliable and cost-efficient production of complex mixed beverages on the basis of the contents of a capsule is permitted.

The object is achieved by the subject matter of the independent claim. Advantageous embodiments are defined, in particular, in the dependent claims, described in the following description or shown in the accompanying drawing.

According to one aspect of the invention, a beverage system for producing a beverage, in particular a mixed beverage, on the basis of contents of a capsule is described. In this case, in particular, a capsule which comprises contents for precisely one portion (for example for a glass) of an (alcoholic or non-alcoholic) beverage may be processed by the beverage system. A portion of a beverage may be produced by the beverage system from the contents (in particular from substantially all of the contents) of a capsule.

The beverage system typically comprises a housing which at least partially encloses an interior of the beverage system. For example, the housing may be cuboidal with four side walls, a bottom and a top wall. The beverage system may be configured, for example, as a home appliance, in particular as a household appliance, which may be placed, for example, on a worktop of a kitchen and/or may be built into a built-in cabinet.

The beverage system may be configured to accommodate a capsule described in this document. The beverage system comprises a capsule support for accommodating a capsule. Moreover, the beverage system comprises a dispensing unit for providing a beverage produced on the basis of the contents of the capsule. Moreover, the beverage system comprises an opening means which is configured to open the one or more outlet openings of the capsule accommodated by the capsule support, so that contents on the lower face of the capsule may flow out of the channel-shaped cavity of the capsule to the dispensing unit. In this case, the capsules and, in particular, the channel-shaped cavity may be arranged directly above the dispensing unit so that the contents from the capsule and/or liquids from the beverage system may flow directly from the channel-shaped cavity to the dispensing unit (for example into a cup on the dispensing unit).

Moreover, the beverage system comprises a carbonizing source which is configured to provide a carbonizing gas (in particular carbon dioxide gas) in the beverage system. The carbonizing source may be, for example, a container (for example a bottle or cartridge) comprising carbonizing gas which is installed or, respectively, inserted in the beverage system.

The beverage system further comprises at least one liquid container for accommodating a liquid. The liquid container may be installed fixedly and/or non-removably in the beverage system. Moreover, the inlet of the liquid container may be decoupled from environmental influences by a closable inlet valve. Thus the shelf life of the liquid may be increased.

Moreover, the beverage system may comprise at least one carbonizer which is configured to carbonize liquid from the liquid container using carbonizing gas from the carbonizing source. The carbonizer is preferably directly arranged in the liquid container so that the carbonized liquid in the carbonizer is cooled by the liquid in the liquid container. Thus a particularly efficient and/or compact construction of a beverage system is permitted.

The beverage system further comprises a liquid line which is configured to conduct non-carbonized liquid directly from the liquid container to the dispensing unit. In this case, the liquid line may be arranged on the bottom of the liquid container in order to remove liquid from the liquid container in a reliable manner. The non-carbonized liquid may be pumped by means of a pump from the liquid container and/or to the dispensing unit.

Moreover, the beverage system comprises a liquid line which is configured to conduct carbonized liquid from the carbonizer to the dispensing unit. The carbonized liquid typically has a certain excess pressure (for example a pressure of 5 bar or more). Thus, by opening a valve, the carbonized liquid may be conducted efficiently from the carbonizer to the dispensing unit (without using an additional pump).

Thus a beverage system is provided by which a carbonized mixed beverage may be efficiently produced.

The beverage system may comprise on the liquid line for the carbonized liquid a pressure compensator which is configured to reduce the pressure of the carbonized liquid from the carbonizer before being provided to the dispensing unit. By reducing the pressure of the carbonized liquid it may be brought about that the carbonized liquid flows in a reliable and controlled manner to the dispensing unit into a receptacle for the mixed beverage (and at the same time in particular does not splash).

The beverage system may comprise a gas line which is configured to conduct carbonizing gas from the carbonizing source to the liquid container in order to fill a cavity of the liquid container, which is not filled with liquid, at least partially with carbonizing gas. Thus an inert gas atmosphere consisting of carbonizing gas may be formed on the surface of the liquid in the liquid container. Thus the shelf life of the liquid may be increased. Moreover, liquid vapors (in particular alcohol vapors) may thus be avoided.

The beverage system may comprise on the gas line between the carbonizing source and the liquid container a pressure throttle which is configured to provide carbonizing gas at a reduced pressure for filling the liquid container. In particular, the beverage system may be configured to provide carbonizing gas at a relatively high pressure (optionally directly from the carbonizing source) for carbonizing the liquid. Moreover, by reducing the pressure, carbonizing gas may be provided at a reduced pressure, for example in order to form a gas atmosphere in the liquid container. Thus an efficient and varied use of carbonizing gas is permitted.

The beverage system may comprise on the gas line between the carbonizing source and the liquid container a valve which is configured to permit or to prevent the supply of carbonizing gas to the liquid container. Thus a gas atmosphere may be adjusted in a precise manner in the liquid container.

The beverage system may comprise a gas line which is configured to conduct carbonizing gas from the carbonizing source to the liquid lines. Moreover, the beverage system may comprise on the gas line between the carbonizing source and the liquid lines a valve which is configured to permit or to prevent the supply of carbonizing gas to the liquid lines. Moreover, the beverage system may comprise a control unit which is configured to open the valve in order to clean and/or to flush the liquid lines with carbonizing gas. For example, the control unit may cause the liquid lines to be flushed with carbonizing gas after the production of a mixed beverage. Thus a high-quality production of mixed beverages may be permitted on a permanent basis.

The beverage system may comprise a gas line which is configured to conduct carbonizing gas from the carbonizing source to the capsule (in particular carbonizing gas at a reduced pressure). Moreover, the beverage system may comprise on the gas line between the carbonizing source and the capsule a valve which is configured to permit or to prevent the supply of carbonizing gas to the capsule.

The control unit may be configured to open the valve to produce a beverage in order to flush contents from the capsule by means of carbonizing gas. In this case, carbonizing gas may be forced in a pulsed manner through the capsule. The control unit may be configured to determine operating data for the production of a beverage. The length or, respectively, the duration of the pulsing of carbonizing gas for flushing the capsule may thus be adjusted as a function of the operating data. For example, the length or, respectively, duration of the pulses may be adapted as a function of the quantity of the contents and/or as a function of the viscosity of the contents of the capsule. Thus a particularly reliable production of a mixed beverage is permitted.

The beverage system may comprise on the gas line between the carbonizing source and the capsule an (optionally manually) adjustable flow limiter which is configured to limit and/or adjust the volume flow of carbonizing gas which is used for flushing the capsule. Thus a reliable operation of the beverage system may be permitted.

The beverage system may comprise an outlet valve which is configured to permit liquid to drain out of the liquid container and/or out of a liquid line. In this case, the outlet valve may be arranged below the liquid container. The provision of an outlet valve permits an efficient cleaning of the beverage system.

As already set out above, the beverage system may comprise a pump which is configured to pump liquid from the liquid container via a liquid line to the dispensing unit, to the carbonizer or in a circulating manner back to the liquid container. Moreover, the beverage system may comprise at least one valve which is configured to conduct liquid, which has been pumped by the pump from the liquid container, selectively to the dispensing unit, to the carbonizer or in a circulating manner back to the liquid container.

The control unit of the beverage system may be configured to activate the pump and/or the valve as a function of an operating state of the beverage system. For example, the pump and the valve may cause the liquid to circulate in order to prevent the liquid freezing in the liquid container when the beverage system is not in the process of producing a mixed beverage. On the other hand, the pump and the valve may cause the liquid to be conducted to the dispensing unit when a mixed beverage is being produced. Moreover, the pump and the valve may cause the liquid to be conducted to the carbonizer in order to refill the carbonizer. Thus an efficient conduction of liquid inside the beverage system is permitted.

The beverage system may be configured, on the basis of carbonizing gas from the carbonizing source, to provide carbonizing gas at a first pressure (for example 4 bar or more) in order to carbonize the liquid in the carbonizer, and to provide carbonizing gas at a second pressure (for example 1 bar or less) in order to generate an inert gas atmosphere in the liquid container in order to clean a liquid line and/or in order to flush the contents out of the capsule. In this case, the first pressure is greater than the second pressure. Thus an efficient use of carbonizing gas inside the beverage system is permitted.

The beverage system may comprise a cleaning mode (which may be activated, for example, by a user of the beverage system via a user interface) which permits carbonizing gas to be conducted from the carbonizing source for the cleaning through the liquid lines, through the carbonizer and/or through the liquid container. Thus a permanent operation of the beverage system is permitted in an efficient manner.

As already set out above, the beverage system may comprise a pump which is configured to pump non-carbonized liquid from the liquid container.

Moreover, the beverage system may comprise a flow meter which is configured to detect sensor data relative to a volume flow of non-carbonized liquid from the liquid container.

On the other hand, the beverage system may comprise a valve which is configured to permit or to prevent a flow of carbonized liquid from the carbonizer. Moreover, the beverage system may comprise a flow meter which is configured to detect sensor data relative to a volume flow of carbonized liquid from the carbonizer.

The control unit of the beverage system may be configured to operate the pump and/or the valve as a function of the sensor data in order to produce a beverage. In particular, the pump may cause a specific quantity of non-carbonized liquid to be pumped to the dispensing unit. Alternatively or additionally, the valve may cause a specific quantity of carbonized liquid to be allowed through to the dispensing unit. Thus a mixed beverage may be produced in a precise manner.

In a preferred example, the beverage system has the components described in this document for two different liquids (for example for water and for an alcoholic liquid). In particular, the beverage system may comprise a first liquid container for accommodating a first liquid, in particular water, as well as a first carbonizer which is configured to carbonize a first liquid from the first liquid container using carbonizing gas from the carbonizing source. Moreover, the beverage system may comprise a second liquid container for accommodating a second liquid, in particular alcohol, as well as a second carbonizer which is configured to carbonize the second liquid from the second liquid container using carbonizing gas from the carbonizing source. Moreover, the beverage system may comprise liquid lines which are configured to conduct liquid directly from the first liquid container, directly from the first carbonizer, directly from the second liquid container and directly from the second carbonizer, in each case to the dispensing unit. By providing a plurality of different liquids, particularly complex mixed beverages may be produced.

It should be noted that any aspects of the system described in this document may be combined together in many different ways. In particular, the features of the claims may be combined together in many different ways.

The invention is described in more detail hereinafter with reference to the exemplary embodiments shown in the accompanying drawing, in which:

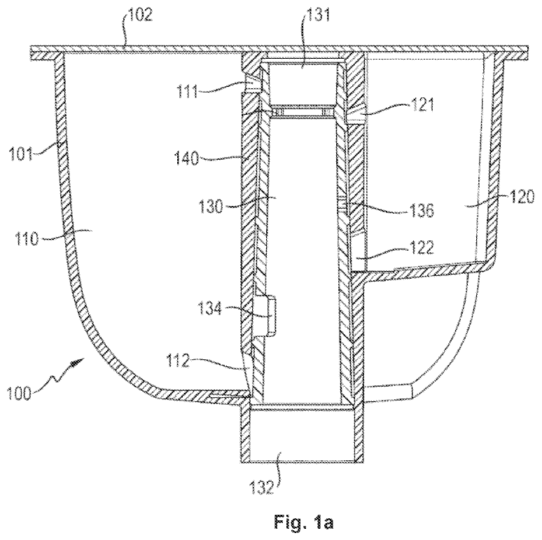

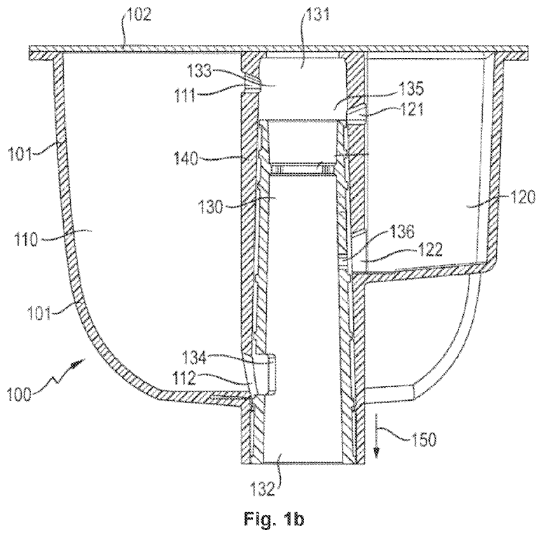

FIG. 1a shows a sectional view through a capsule with a valve in a closed state;

FIG. 1b shows a sectional view of the capsule of FIG. 1a with a valve in an open state;

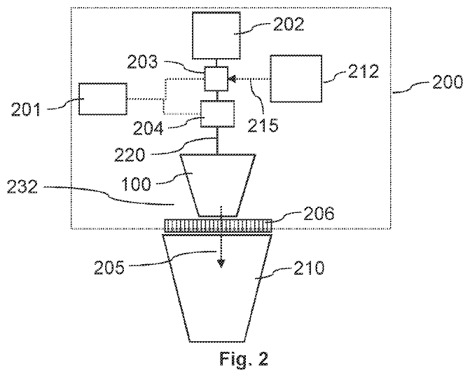

FIG. 2 shows a block diagram of an exemplary beverage system; and

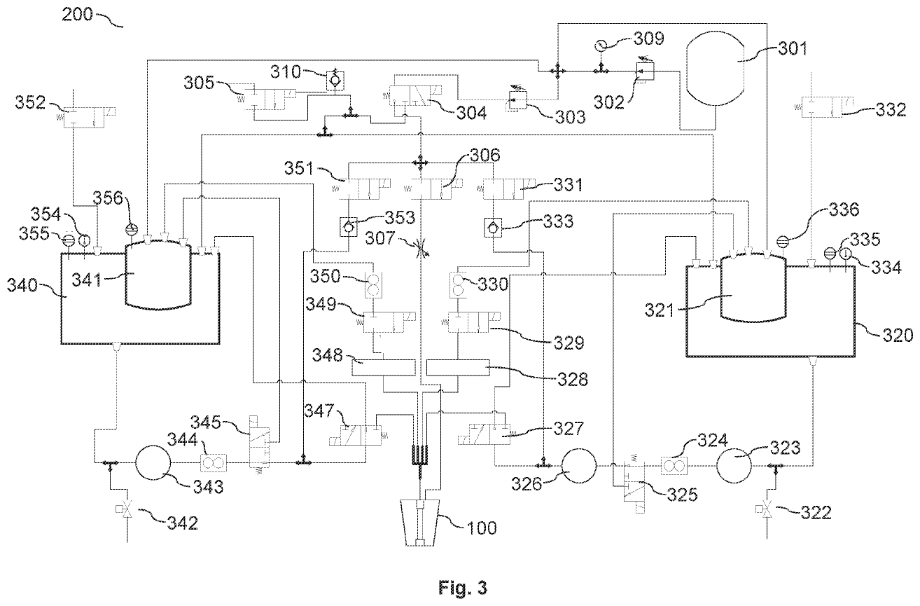

FIG. 3 shows exemplary modules of a beverage system.

As set out in the introduction, the present document relates to the reliable production of a beverage on the basis of the contents of a capsule.

In this connection, FIG. 1a shows an exemplary capsule, in particular an exemplary multi-chamber capsule 100. The capsule 100 shown in FIG. 1a comprises two chambers 110, 120, wherein the chambers 110, 120 are formed by separate shells or, respectively, receptacles. The chambers 110, 120 may be used to store different contents separately from one another. By the provision of a plurality of chambers 110, 120 for different contents, the shelf life of the contents of a capsule 100 may be increased.

The capsule 100 may be used in a beverage system or, respectively, a beverage vending machine for producing mixed beverages. In this case alcohol-containing and/or non-alcoholic beverages may be produced. The production of a portion of a beverage may be brought about by combining the contents (for example liquids) stored inside a capsule 100 with a liquid flow provided by the beverage system. In this case, a contamination of the beverage system by the contents of a capsule 100 is intended to be avoided as far as possible in order to be able to use the beverage system in an efficient and convenient manner for producing a plurality of portions, optionally of various types of beverage.

The capsule 100 shown in FIG. 1a comprises a capsule body 101 by which the one or more chambers 110, 120 of the capsule 100 are formed. The capsule body 101 may be covered by a lid 102, wherein the lid 102 may be formed by a sealing film. Moreover, the capsule 100 comprises a valve 130, 140, wherein the valve 130, 140 comprises a valve housing 140 (generally also denoted as the chamber wall) in which a closure part 130 is arranged. The valve housing 140 may be part of the capsule body 101 and may form at least partially the one or more chambers 110, 120. In particular, in each case the valve housing 140 may form at least one wall of the one or more chambers 110, 120. The closure part 130 may be moved inside the valve housing 140 in order to open or, respectively, to close the valve 130, 140.

The valve housing 140 encloses in the example shown in FIG. 1a a (circular) cylindrical space in which the closure part 130 may be moved in a translatory manner in order to open or, respectively, to close the valve 130, 140. In particular, the valve 130, 140 may be opened when the closure part 130 is moved downwardly and closed when the closure part 130 is moved upwardly.

The valve housing 140 has in an upper region or, respectively, in the vicinity of an upper face of the capsule 100 a first inlet opening 111 for the first chamber 110 and a second inlet opening 121 for the second chamber 120. An inlet opening 111, 112 may be used to supply a chamber 110, 120 with a flushing medium, in order to flush the contents from the chamber 110, 120. Alternatively or additionally, an inlet opening 112, 112 may be used to ventilate a chamber 110, 120 in order to permit the contents of a chamber 110, 120 to run out (optionally solely brought about by gravitational force).

Moreover, the valve housing 140 has in a lower region or, respectively, in the vicinity of a lower face of the capsule 100 a first outflow opening 112 for the first chamber 110 and a second outlet opening 122 for the second chamber 120. The contents of a chamber 110, 120 may run out of the chamber 110, 120 via an outlet opening 112, 112.

In a closed state of the valve 130, 140 the closure part 130 may be configured to close the openings 111, 112, 121, 122 of the one or more chambers 110, 120. On the other hand, the openings 111, 112, 121, 122 may be opened by a movement of the closure part 130 so that the contents of the one or more chambers 110, 120 may run out (optionally by using a flushing medium which may be supplied to the one or more chambers 110, 120 via the one or more inlet openings 112, 112). To this end, the closure part 130 may have a first through-hole 134 for opening the first chamber 110 and optionally a second through-hole 136 for opening the second chamber 120. The one or more through-holes 134, 136 (of the closure part wall) of the closure part 130 may be brought in front of the outlet openings 112, 122 of the valve housing 140 by a movement of the closure part 130, so that one or more outlet channels from the one or more chambers 110, 120 is provided through the outlet openings 112, 122 and through-holes 134, 136 into a channel-shaped cavity of the closure part 130.

The closure part 130 may have a (cylindrical or, respectively, channel-shaped) cavity which extends from an upper end 131 of the closure part 130 to a lower end 132 of the closure part 130. The cavity in this case is enclosed by the closure part wall of the closure part 130, wherein the through-holes 134, 136 are formed by through-holes in the closure part wall of the closure part 130. The cavity of the closure part 130 may be positioned within a beverage system over a container for a beverage such that the contents flowing out of a chamber 110, 120 may flow directly from the channel-shaped cavity into the container without coming into contact with a component of the beverage system. Thus contamination of a beverage system may be avoided in an efficient and reliable manner.

FIG. 1b shows the capsule 100 of FIG. 1a in an open state. In particular, FIG. 1b shows how a through-hole 134, 136 of the closure part 130 may be moved in front of an outlet opening 112, 122 of a chamber 110, 120 by a movement 150 of the closure part 130. Moreover, FIG. 1b also shows how a passage 133, 135 of the closure part 130 may be moved in front of an inlet opening 111, 121 of a chamber 110, 120. Thus it may be brought about that the contents of one or more chambers 110, 120 may flow out of the capsule 100 via the channel-shaped cavity of the closure part 130. Optionally via a through-hole 133, 135 of the closure part 130 and via an inlet opening 111, 121 of a chamber 110, 120 a flushing medium may be passed into the chamber 110, 120 in order to flush out the contents from the chamber 110, 120.

FIG. 2 shows a block diagram of an exemplary capsule system or, respectively, beverage system 200. The capsule system 200 comprises a control unit 201 which is configured to control the production process (of a portion) of a beverage. A capsule 100 may be transferred by a user to the beverage system 200 (into a capsule accommodating unit of the system 200 provided therefor). The capsule may then be optionally transferred via optional conveying means (for example via a conveying carriage) to a processing position 232 in the interior of a housing of the capsule system 200. The conveying means may be activated by the user (for example by actuating a knob or directly by inserting the capsule 100). When the capsule 100 arrives at the processing position 232 then the production process may be started.

During the course of the production process the control unit 201 causes an opening means 220 for opening the capsule 100 (for example a (hollow) needle or, respectively, lance) to be guided toward the capsule 100. To this end, it is possible to activate an actuator 204 which guides the opening means 220 toward the capsule 100 in order to open the capsule 100. Moreover, a further actuator 203 may be activated in order to force a flushing medium (for example from a container 202 of the system 200) into the capsule 100 in order to flush at least one chamber 110, 120 in the capsule 100. By opening the capsule 100 and optionally by flushing one or more chambers 110, 120 of the capsule 100, the contents of the one or more chambers 110, 120 may flow out of the capsule 100. A cup 210, in which the beverage to be created is provided to the user, may be positioned below a dispensing unit 206 of the system 200. The system 200 may be configured such that a contents mixture 205 (which comprises the contents and optionally a flushing medium and/or one or more other liquids) flows out of the one or more chambers 110, 120 of the capsule 100 directly via the dispensing unit 206 into the cup 210.

The system 200 may also be configured to fill further one or more liquids 215 into the cup 210 (for example from a container 212) for the beverage to be created. The liquid 215 may comprise, for example, alcohol. In this case the liquid 215 may be transferred through the channel-shaped cavity 138 of the valve 130, 140 of a capsule 100 into the cup 210. Thus a reliable mixing of a beverage may be brought about.

A mixed beverage may be produced in a reliable manner by the capsule system or, respectively, beverage system 200 shown in FIG. 2, without contaminating the capsule system or, respectively, the beverage system 200.

FIG. 3 shows exemplary modules or, respectively, components of a beverage system 200. The beverage system 200 shown in FIG. 3 comprises a first container 340, 202 for a first liquid (for example for water) as well as a second container 320, 212 for a second liquid (for example for an alcoholic liquid). The containers 320, 340 may be stainless steel containers. The containers 320, 340 may be used to accommodate a non-carbonized liquid. The (non-carbonized) liquid may be removed in each case at the base or, respectively, bottom of the respective container 320, 340.

The containers 320, 340 may have in each case a carbonizer 321, 341 which is configured in each case to carbonize liquid from the respective container 320, 340. The carbon dioxide for the carbonizing may be taken from a CO₂ container 301 (for example an insertable cartridge or bottle). The carbon dioxide gas may have a pressure of 5 bar or more. The first container 340 has a receiving volume of, for example, 10 liters or more (for example of 12 liters). The second container 320 has, for example, a receiving volume of 2 liters or more (for example of 4 liters). The first carbonizer 341 may have a volume of 1 liter or more (for example 1.2 liters). The second carbonizer 321 may have a volume of 0.5 liters or more (for example 0.7 liters). In each case a carbonized liquid may be provided via the carbonizer 321, 341.

The containers 320, 340 may have in each case a level sensor 335, 355 which is configured to detect sensor data relative to the level of liquid in the respective container 320, 340. The sensor data may be provided by means of a capacitive level measurement. In particular, the change in capacitance between two measuring electrodes may be measured in order to detect sensor data relative to the level of the container 320, 340.

Alternatively or additionally, the carbonizer 321, 341 may have in each case a level sensor 336, 356 in order to detect sensor data relative to the level of liquid in the respective carbonizer 321, 341. The level may be detected, for example, by means of one or two measuring electrodes.

The carbonizers 321, 341 may have in each case an overpressure valve (not shown), wherein an overpressure valve is configured to reduce the pressure in the respective carbonizer 321, 341 (by discharging gas) when a limit pressure is reached or exceeded. The limit pressure may be, for example, 11 bar or more.

The carbonizers 321, 341 may be arranged in each case inside the respective liquid container 320, 340 in order to bring about a cooling of the carbonized liquid in the respective carbonizer 321, 341 by the surrounding liquid.

The carbon dioxide gas may be provided via a check valve from the CO₂ container 310, wherein the check valve may be integrated in the connection of the CO₂ line to the carbonizer 321, 341. Correspondingly, liquid from the respective container 320, 340 may be provided in the respective carbonizer 321, 341 via a check valve (which may be integrated in the connection of the liquid line).

A container 320, 340 may comprise a temperature sensor 334, 354 which is configured to detect sensor data relative to the temperature of the liquid in the container 320, 340. The temperature sensor 334, 354 is preferably arranged in the vicinity of the removal point of the liquid from the container 320, 340 (for example at the bottom of the container 320, 340).

The liquid may be filled via a valve 332, 352 into a container 320, 340. In this case the valve 332, 352 may have a relatively large opening (for example DN10 or more, for example DN14) in order to permit a rapid filling of the container 320, 340 with liquid. The valve 332, 352 may be an (electric) solenoid valve. By closing the valve 332, 352 the container 320, 340 may be sealed from environmental influences. Thus the evaporation of liquid (in particular alcohol) and/or the formation of algae (in particular in the case of water) may be reduced and/or avoided. The valve 332, 352 may be (electrically) opened in order to permit a user to fill (non-carbonized) liquid into the container 320, 340.

The beverage system 200 may have a pump 323, 343 which is configured to pump (non-carbonized) liquid from a container 320, 340. The pump 323, 343 may be configured to pump in idle mode or, respectively, empty. The pump 323, 343 may be a (three chamber) membrane pump. The pump 323, 343 may be used to circulate the liquid continuously and/or repeatedly in the container 320, 340 in order to avoid the situation where the liquid freezes in the container 320, 340. The pump 323, 343, for example, may be automatically activated when the temperature of the liquid reaches or falls below a specific temperature threshold (for example −10° C. in the case of alcohol). The circulation of the liquid may be brought about by a corresponding adjustment of the distribution valve 325, 345 and the distribution valve 327, 347. Alternatively or additionally, the pump 323, 343 may be used to pump liquid from the container 320, 340 counter to the pressure of the carbon dioxide gas in the carbonizer 321, 341 (with a corresponding adjustment of the distribution valve 325, 345).

The pump speed of the pump 323, 343 may be changed by adjusting the pulse width of PWM (pulse width modulated) signals. The pump speed may be selected to be relatively small, for example for the circulation of liquid, in order to keep the noise emissions of the beverage system 200 low. On the other hand, the pump speed may be adapted in order to adjust the speed at which the liquid is pumped through the capsule 100 into a receptacle 210 for a mixed beverage. The pumping of liquid into or, respectively, through the capsule 100 may be brought about by a corresponding adjustment of the distribution valve 327, 347.

The beverage system 200 may comprise a flow meter 324, 344 which is configured to measure the quantity of (non-carbonized) liquid which is pumped out of a container 320, 340. The quantity of liquid which is supplied to a mixed beverage may be measured on the basis of the sensor data of the flow meter 324, 344. Moreover, the sensor data of the flow meter 324, 344 may be used to determine the level of liquid in a carbonizer 321, 341. Moreover, the remaining level of liquid in the container 320, 340 may be determined on the basis of the sensor data of the flow meter 324, 344 (for example if the level sensor 335, 355 is only able to detect whether a maximum level is reached or not).

The beverage system 200 may comprise a flow meter 330, 350 which is configured to measure the quantity of (carbonized) liquid which is forced out of a carbonizer 321, 341. The quantity of (carbonized) liquid which is supplied to a mixed beverage may be measured on the basis of the sensor data of the flow meter 330, 350. Moreover, the sensor data of the flow meter 330, 350 may be used to determine the level of liquid in a carbonizer 321, 341.

The beverage system 200 may comprise a valve 329, 349 (for example a solenoid valve) which is configured to be opened or, respectively, closed in order to cause carbonized liquid to be conducted from a carbonizer 321, 341 to the capsule 100 or not. In this case the valve 329, 349 is designed for a relatively high pressure (for example 5 bar or more).

The beverage system 200 comprises a pressure transducer or, respectively, pressure compensator 328, 348 which is configured to reduce the pressure of the carbonized liquid from a carbonizer 321, 341. In particular, the pressure at which the carbonized liquid is supplied to the mixed beverage may be adjusted by means of the pressure transducer or, respectively, pressure compensator 328, 348. The pressure transducer or, respectively, pressure compensator 328, 348 may optionally be manually adjustable (for example during the course of the manufacture of the beverage system 200). By adjusting the pressure of the carbonized liquid, the quality and reliability of the production of a mixed beverage may be increased.

The beverage system 200 may have a (manual) valve 322, 342 (for example a ball valve) by which liquid may be discharged from a container 320, 340 in order to empty the container 320, 340 (completely). The valve 322, 342 is preferably arranged at the lowest point of the liquid circuit of the beverage system 200 in order to permit a reliable emptying.

The beverage system 200 may comprise a heating unit 326 which is configured to heat a liquid from a container 320, 340 (in particular an alcoholic liquid). For example, (depending on the mixed beverage to be produced) the liquid from a container 320, 340 may be heated as required (for example to room temperature). On the other hand, it is possible to prevent the liquid for certain mixed beverages from being heated. The heating unit 326 thus may be activated as required in order to heat the liquid from a container 320, 340.

The beverage system 200 may have a pressure sensor 309 which is configured to detect sensor data relative to the pressure of the carbon dioxide gas which is provided from the CO₂ container 301. On the basis of the sensor data of the pressure sensor 309 it may be determined whether the CO₂ container 301 still contains sufficient carbon dioxide gas or not. If it is identified that insufficient carbon dioxide gas is present, an instruction may be output via a user interface of the beverage system 200 to the effect that the CO₂ container 301 is to be filled up or replaced. Thus a uniformly high quality of mixed beverages may be ensured. Moreover, in this manner a reliable cleaning of the beverage system 200 by means of carbon dioxide gas may be permitted.

The valve 327, 347 (for example a solenoid valve) may cause (non-carbonized) liquid to be conducted through the capsule 100 into the mixed beverage. The valve 329, 349 (for example a solenoid valve) may cause (carbonized) liquid to be conducted through the capsule 100 into the mixed beverage. The valve is typically configured for a higher pressure than the valve 327, 347. Moreover, the valve 329, 349 typically has a greater diameter (DN) than the valve 327, 347.

The beverage system 200 may have a pressure regulator (for example a pressure throttle) 302 which is configured to adjust (in particular to reduce) the pressure of the carbon dioxide gas from the CO₂ container 301 to a specific target pressure (for example 5 bar). The pressure regulator 302 may be adjustable, for example, manually (during the course of the manufacture of the beverage system 200). Defined pressure conditions may be provided in the beverage system 200 by the pressure regulator 302.

The beverage system 200 may have a pressure throttle 303 which is configured to reduce the pressure of the carbon dioxide gas to a reduced pressure (for example 0.1 to 0.3 bar). The carbon dioxide gas at reduced pressure may be used to create an inert atmosphere in a container 320, 340 (in order to increase the shelf life of a liquid) and/or in order to bring about a cleaning of the beverage system 200.

The carbon dioxide gas at the reduced pressure may be conducted via a distribution valve 304 (for example a solenoid valve) to a container 320, 340 in order to create an inert gas atmosphere in the container 320, 340. Thus the shelf life of a liquid may be increased. Moreover, it is possible to avoid in this manner that liquid gas (in particular alcohol vapor) collects in a container 320, 340. Alternatively, the carbon dioxide gas may be conducted to the valves 331, 351, 306 at the reduced pressure.

The beverage system 200 may comprise a cleaning valve 331, 351 which is configured to conduct carbon dioxide gas at reduced pressure through the liquid lines of the beverage system 200 after a mixed beverage has been produced. Thus the liquid lines may be cleaned by carbon dioxide gas after the production of a mixed beverage. The carbon dioxide gas at reduced pressure may be conducted via a check valve 333, 353 into the liquid lines. By means of the check valve 333, 353 it is possible to prevent liquid from passing into a line for carbon dioxide gas.

The beverage system 200 comprises a valve 306 which is configured to conduct carbon dioxide gas at reduced pressure through the capsule 100. The valve 306 may be opened during the production of a mixed beverage in order to use the carbon dioxide gas at reduced pressure as a flushing medium for flushing out the contents from a capsule 100. Thus it is possible to empty a capsule 100 as fully as possible. The valve 306 may be opened in a pulse-like manner, wherein the length of the pulses may depend on the mixed beverage to be produced. In particular, the length of the pulses may depend on the type and/or the quantity of contents which are to be flushed out of the capsule 100. Thus the production process may be accelerated. Moreover, in this manner the quality of the mixed beverages to be produced may be increased.

The beverage system 200 may comprise an (adjustable) flow limiter 307 by which it is possible to reduce the amount of through-flow of carbon dioxide gas for flushing a capsule 100. Thus the speed of emptying or, respectively, flushing a capsule 100 may be adjusted. The flow limiter 307 may optionally be manually adjusted during the manufacture of the beverage system 200.

The beverage system 200 may have a pressure relief valve 310 which is configured to discharge carbon dioxide gas from the region at reduced pressure, when the carbon dioxide gas at reduced pressure has a pressure which reaches or exceeds a specific pressure threshold value (for example 0.7 bar). Thus a safe operation of the beverage system 200 may be ensured.

The beverage system 200 may comprise a ventilation valve 305 which is closed in normal operation. The ventilation valve 305 is connected via one or more lines to the one or more containers 320, 340. The ventilation valve 305 may be opened, in particular, when a container 320, 340 is filled with liquid. Thus a reliable filling of a container 320, 340 may be permitted.

The beverage system 200 may have a cooling unit (not shown) in order to cool a container 320, 340 (in particular the wall of a container 320, 340). For example, the first liquid, (for example water) may be cooled to a temperature of between 1° C. and 5° C. The second liquid, (for example alcohol) may for example be cooled to a temperature of between −12° C. and −8° C. Thus the shelf life of the liquids may be increased.

The beverage system 200 may comprise a sensor (not shown) which is configured to detect whether a receptacle 210 is arranged on the dispensing unit 206 or not. The control unit 201 may be configured to prevent the production of a mixed beverage if it is identified that no receptacle is located on the dispensing unit 206. Thus a safe and convenient operation of the beverage system 200 may be permitted.

Moreover, the control unit 201 may be configured to change the height of a receptacle 210 in order to permit a safe and reliable production of a mixed beverage. To this end, an (electrically) height-adjustable storage surface for a receptacle 210 may be arranged on the dispensing unit 206.

Moreover, the beverage system 200 may have a sensor which is configured to detect sensor data relative to the capacity of a receptacle 210. The control unit 201 may be configured to determine on the basis of the sensor data whether the receptacle 210 has a sufficiently large capacity for the mixed beverage to be produced or not. Optionally, the production of a mixed beverage may be prevented if it is determined that the receptacle 210 does not have a sufficiently large capacity. Thus a mixed beverage may be produced in a reliable manner.

The level of carbonizing of the mixed beverage may be adjusted by mixing a specific quantity of a carbonized liquid with a specific quantity of a non-carbonized liquid in a precise manner.

The components described in this document for the first liquid (for example water) and for the second liquid (for example alcohol) may be identical for both liquids, which permits an efficient construction of a beverage system.

For producing a mixed beverage a user can insert a capsule 100 into a receiver of a capsule holder of the beverage system 200. One or more parameters, (for example degree of carbonizing, quantity of alcohol, temperature etc.) may be input via a user interface of the beverage system 200. The control unit 201 of the beverage system 200 may be configured to determine operating parameters for the production of a mixed beverage (for example on the basis of a user input and/or on the basis of stored data for various types of mixed beverages). The data for a mixed beverage may be stored locally in the beverage system 200 or on an external storage unit (for example a cloud).

The capsule 100 may have a machine-readable code (for example a 2D barcode). The beverage system may have a reading unit which is configured to read data from the code of the capsule 100. In particular, operating parameters for the beverage system 200 may be determined on the basis of the data from the code of a capsule 100.

The capsule 100 is opened by an opening means 220. Then the liquids may be conducted into the mixed beverage one after the other. A preferred sequence in this case is: 1) carbonized alcohol; 2) carbonized water; 3) non-carbonized alcohol; 4) non-carbonized water. The change from one liquid to the next takes place after the respectively required quantity of liquid for a mixed beverage has been measured by the flow meter 324, 344 or, respectively, 330, 350. Moreover, the valve 306 may be opened in a pulse-like manner in order to flush through the capsule 100 and in order to drive the contents (for example a syrup) out of the capsule 100 in this manner. A precise metering of the liquids may be permitted by the sequential supply of the various liquids. Alternatively, the liquids may be supplied at least partially parallel to one another.

After the liquids have been supplied by opening the valves 331, 351, a cleaning of the liquid lines may be brought about. Moreover, a dripping of liquid may be avoided in this manner. Furthermore, by cleaning the liquid lines a precise metering may be permitted during a subsequent production of a mixed beverage.

After the production of a mixed beverage the opening means 220 may be raised again and the capsule 100 may optionally be moved automatically into a waste container. Moreover, the one or more carbonizers 321, 341 may be automatically refilled (from the respective liquid container 320, 340).

The beverage system 200 may permit an automatic or semi-automatic cleaning process. In this case, a cleaning liquid may be circulated in the liquid circuit. Moreover, a flushing with water may then be brought about.

The present invention is not limited to the exemplary embodiments shown. In particular it should be noted that the description and the figures are only intended to illustrate the principle of the proposed system.

1-16. (canceled)

17. A beverage system for producing a beverage based on contents of a capsule, wherein the beverage system comprises:
a capsule support for accommodating the capsule;
a dispensing unit for providing the beverage produced based on the contents of the capsule;
an opening device configured to open the capsule accommodated by said capsule support, so that the contents may pass from the capsule to said dispensing unit;
a carbonizing source configured to provide a carbonizing gas in the beverage system;
at least one liquid container for accommodating a liquid;
at least one carbonizer configured to carbonize liquid from said at least one liquid container using said carbonizing gas from said carbonizing source; and
a first liquid line configured to conduct non-carbonized liquid directly from said at least one liquid container to said dispensing unit; and
a second liquid line configured to conduct carbonized liquid from said at least one carbonizer to said dispensing unit.

18. The beverage system according to claim 17, further comprising a pressure compensator arranged on said second liquid line, said pressure compensator being configured to reduce a pressure of carbonized liquid from said carbonizer before the carbonized liquid is provided to said dispensing unit.

19. The beverage system according to claim 17, further comprising a gas line configured to conduct carbonizing gas from said carbonizing source to said liquid container in order to fill a cavity of said liquid container, which cavity is not filled with liquid, at least partially with carbonizing gas.

20. The beverage system according to claim 19, further comprising a pressure throttle arranged on said gas line between said carbonizing source and said liquid container, said pressure throttle being configured to provide carbonizing gas at a reduced pressure for filling said liquid container.

21. The beverage system according to claim 19, further comprising a valve arranged on said gas line between said carbonizing source and said liquid container, said valve being configured to permit or to prevent the supply of carbonizing gas to said liquid container.

22. The beverage system according to claim 17, further comprising:
a gas line configured to conduct carbonizing gas from said carbonizing source to said first and second liquid lines;
a valve arranged on said gas line between said carbonizing source and said first and second liquid lines, said valve being configured to permit or to prevent the supply of carbonizing gas to said first and second liquid lines; and
a control unit configured to open said valve in order to clean and/or to flush said first and second liquid lines with carbonizing gas.

23. The beverage system according to claim 17, further comprising:
a gas line configured to conduct carbonizing gas from said carbonizing source to the capsule;
a valve on said gas line between said carbonizing source and the capsule, said valve being configured to permit or to prevent the supply of carbonizing gas to the capsule; and
a control unit configured to open said valve to produce a beverage in order to flush contents from the capsule by means of carbonizing gas.

24. The beverage system according to claim 23, wherein said control unit is configured to determine operating data for the production of a beverage, and to adjust a length of a pulsing of carbonizing gas to flush contents from the capsule as a function of said operating data.

25. The beverage system according to claim 23, further comprising an adjustable flow limiter on said gas line between said carbonizing source and the capsule, said adjustable flow limiter being configured to limit and/or adjust a volume flow of carbonizing gas which is used to flush contents from the capsule.

26. The beverage system according to claim 17, further comprising an outlet valve arranged below said liquid container, said outlet valve being configured to permit liquid to drain out of said liquid container and/or out of said first and/or second liquid line.

27. The beverage system according to claim 17, further comprising a pump configured to pump liquid from said liquid container via said first or second liquid line to said dispensing unit, to said carbonizer, or in a circulating manner back to said liquid container.

28. The beverage system according to claim 27, further comprising:
at least one valve configured to conduct liquid which has been pumped by said pump from said liquid container, selectively to said dispensing unit, to said carbonizer or in a circulating manner back to said liquid container; and
a control unit configured to activate said pump and/or said at least one valve as a function of an operating state of the beverage system.

29. The beverage system according to claim 17, wherein the beverage system is configured, based on carbonizing gas from said carbonizing source, to provide carbonizing gas at a first pressure in order to carbonize liquid in said carbonizer, and to provide carbonizing gas at a second pressure in order to generate an inert gas atmosphere in said liquid container in order to clean said first or second liquid line and/or in order to flush contents out of the capsule; and said first pressure is greater than said the second pressure.

30. The beverage system according to claim 17, further comprising a cleaning mode which permits carbonizing gas to be conducted from the carbonizing source for the cleaning through the first and second liquid lines, through the carbonizer, or through the liquid container.

31. The beverage system according to claim 17, further comprising:
a pump configured to pump non-carbonized liquid from said liquid container;
a first flow meter configured to detect sensor data relative to a volume flow of non-carbonized liquid from said liquid container;
a valve configured to permit or to prevent a flow of carbonized liquid from said carbonizer;
a second flow meter configured to detect sensor data relative to a volume flow of carbonized liquid from said carbonizer; and
a control unit configured to operate said pump and/or said valve as a function of said sensor data in order to produce a beverage.

32. The beverage system according to claim 17, wherein:
said at least one liquid container is one of a first liquid container and a second liquid container; said first liquid container is configured to accommodate a first liquid and said second liquid container is configured to accommodate a second liquid;
said at least one carbonizer is one of a first carbonizer and a second carbonizer; said first carbonizer is configured to carbonize said first liquid from said first liquid container using carbonizing gas from said carbonizing source and said second carbonizer is configured to carbonize said second liquid from said second liquid container using carbonizing gas from said carbonizing source; and
said first and second liquid lines are configured to conduct liquid directly from said first liquid container, directly from said first carbonizer, directly from said second liquid container and directly from said second carbonizer respectively to said dispensing unit.

33. The beverage system according to claim 32, wherein said first liquid accommodated in said first liquid container is water; and said second liquid accommodated in said second liquid container is alcohol.
